(19) United States
(12) Patent Application Publication
(10) Pub. No.: US 2008/0168621 A1
(43) Pub. Date: Jul. 17, 2008

(54) Glass door hinge structure

(75) Inventor: Ching-Yi Lin, Changhua Hsien (TW)

Correspondence Address: RABIN & Berdo, PC, 1101 14TH STREET, NW, SUITE 500, WASHINGTON, DC, 20005, US

(73) Assignee: Lin Kun Ta Industrial Co., Ltd., Changhua Hsien (TW)

(21) Appl. No.: 11/543,850

(22) Filed: Oct. 6, 2006

(51) Int. Cl. E05D 5/02

(52) U.S. Cl. 16/252

(57) ABSTRACT

A glass door hinge structure includes a hinge body, a hinge cover, an axial bolt and a fixing base. After a glass door is installed between a hinge body and a hinge cover and the fixing base is fixed on the ground, both edges of the glass door can be adjusted to an angle to provide a smooth and neat glass door by turning two long screw bolts of an extending body installed adjacent to a hole base on the fixing base. With such connection of the long screw bolts to the extending body, the screw thread will not be damaged easily. With the resilience provided by the long spring coil installed in both edges of the through hole that is disposed transversally in the protrusion of the hinge body, the life expectancy can be extended and the two glass doors can resume their closing position quickly.

### BACKGROUND OF THE INVENTION

1. Field of the Invention

The present invention relates to a glass door hinge structure, and more particularly to a glass door hinge structure that can be adjusted to an angle to make neat and smooth edges on both sides of the glass door after the glass door is installed at a position between a hinge body and a hinge cover and the fixing base is fixed on the ground, such that both edges of the glass door can be adjusted to an angle to provide a smooth and neat glass door, and such structure can prevent a long screw bolt from being damage after a long time of use, so as to extend the life expectancy and provide a convenient and quick way of opening and closing the glass door.

2. Description of the Related Art

Referring to FIGS. 1A, 1B and 1C for a general traditional glass door hinge structure, the structure includes a hinge body A, a hinge cover B, an axial bolt C and a fixing base D, and the internal surface of the hinge body A attached with the hinge cover B has a protrusion A1, and the protrusion A1 has a through hole A2 disposed transversally as shown in FIG. 1C, and both distal positions of the through hole A2 separately have a thread section for installing and combining a sleeve A3, a spring coil A4, and a rotating screw bolt A5, and the center of the through hole A2 has a vertical inner hole A6 for installing an axial bolt C and a groove C1 disposed at both upper sides of the axial bolt C for pressing against the sleeve A3, and the lower end of the axial bolt C is situated in a hole base D1 of a fixing base D fixed onto the ground, and then a screw bolt E is screwed into a screw hole D2 of the hole base D1 for contacting and fixing the axial bolt C. After a glass door F is installed at a position between the hinge body A and the hinge cover B, and the fixing base D is fixed onto the ground, both edges of the glass door F cannot be aligned linearly in a plane, and thus causing tremendous troubles to construction workers.

Further, a spring coil A4 installed in the through hole A2 that is transversally disposed at the protrusion A1 of the hinge body A comes with different lengths, and thus the speed of resuming the glass door F to the closed position becomes very slow, and makes the glass door F look like that it cannot be closed at all.

### SUMMARY OF THE INVENTION

In view of the foregoing shortcomings of the present invention, the inventor of the present invention based on years of experience on the related field to conduct extensive experiments and modifications and finally developed a glass door hinge structure in accordance with the present invention.

Therefore, it is a primary objective of the present invention to overcome the shortcomings of the prior art by providing a glass door hinge structure that comprises a hinge body, a hinge cover, an axial bolt, and a fixing base, wherein a protrusion is disposed on the hinge body and attached to an internal surface of the hinge cover, and a through hole is disposed transversally on the protrusion, and a thread section is disposed separately on both distal positions of the through hole for installing and combining a protruding bolt, a long spring coil, and a rotating screw bolt, and a vertical inner hole is disposed at the center of the through hole for installing an axial bolt, such that a groove disposed separately on both upper sides of the axial bolt presses the protruding bolt by the resilience of the long spring coil. The bottom of the axial bolt is situated and fixed into a center hole of the hole base in the fixing base, and two long screw bolts are screwed into the fixing base and extended out from the hole base into an inner screw hole of an extending body for contacting two sunken surfaces on both lower left and right sides of the axial bolt. After the glass door is installed at a position between the hinge body and the hinge cover, and the fixing base is fixed on the ground, the movement of the two long screw bolts of the extending body on the fixing base can adjust the angle for both edges of the glass door to make a smooth and neat glass door, and the structure comes with enhanced long screw bolts and thus the glass door hinge structure will not be damaged easily.

Another objective of the present invention is to provide a glass door hinge structure, wherein a long spring coil is installed to both sides of a through hole transversally disposed in a protrusion of a hinge body for enhancing the resilience, and thus extending the life expectancy and providing a quick and convenient way of resuming the glass door to its closed position.

### BRIEF DESCRIPTION OF THE DRAWINGS

FIG. 1A is a schematic view of an installing position of a prior art structure;

FIG. 1B is an exploded view of a prior art structure;

FIG. 1C is a perspective view of a prior art structure;

FIG. 2A is an exploded view of a structure of the present invention;

FIG. 2B is a perspective view of an assembly of the present invention;

FIG. 3 is a schematic view of an installing position of the present invention;

FIG. 4A is a schematic view of an assembly of the present invention;

FIG. 4B is another schematic view of an assembly of the present invention;

FIG. 5A is an exploded view of another form of the present invention;

FIG. 5B is a cross-sectional view of another form of the present invention; and

FIG. 6 is a schematic view of an installing position of another form of the present invention.

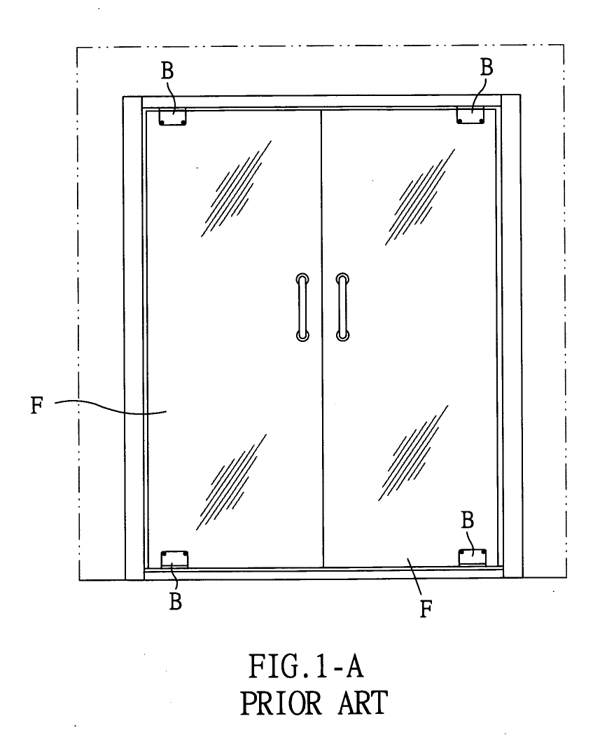

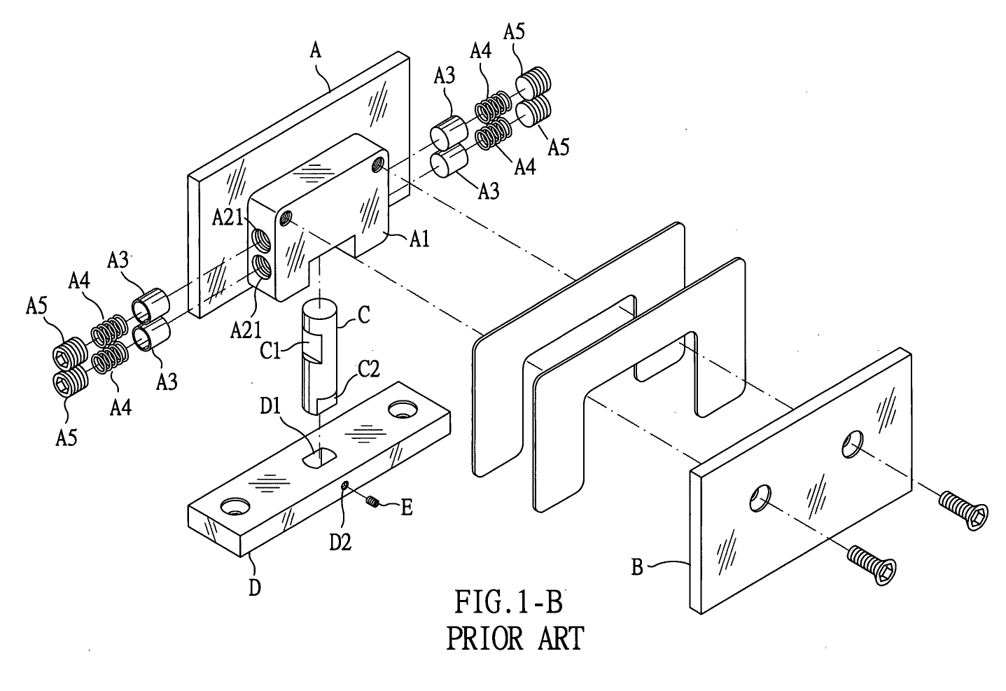

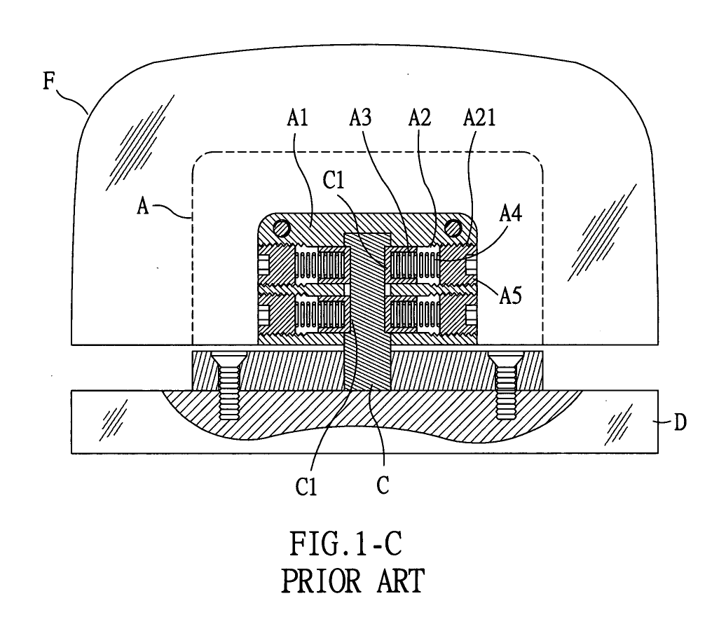

### DETAILED DESCRIPTION OF THE PREFERRED EMBODIMENTS

The above and other objects, features and advantages of the present invention will become apparent from the following detailed description taken with the accompanying drawing.

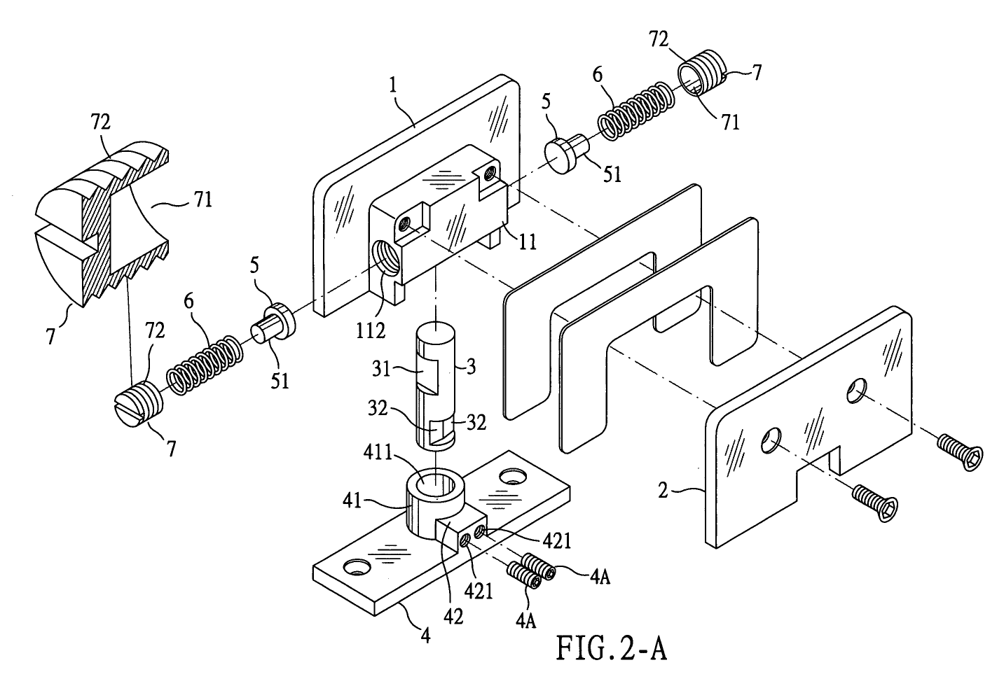

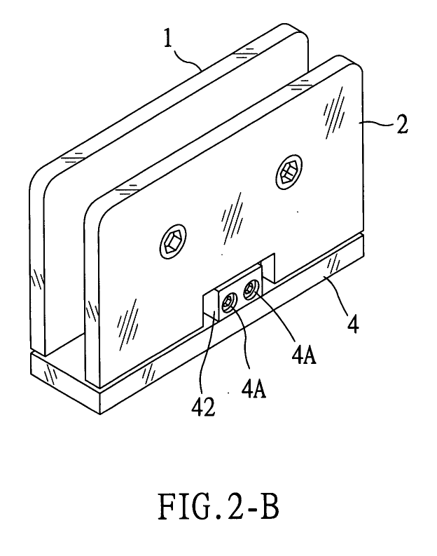

Referring to FIGS. 2A and 2B for the detailed description of the present invention, a glass door hinge structure comprises a hinge body 1, a hinge cover 2, an axial bolt 3, and a fixing base 4, wherein the hinge body 1 has a protrusion 11 disposed on an internal surface of the hinge cover 2, and the protrusion 11 has a transversally disposed through hole 111, and both distal positions of the through hole 111 separately have a thread section 112, for installing and connecting a protruding bolt 5, a long spring coil 6, and a rotating screw bolt 7. Both ends of the long spring coil 6 are clamped and fixed by a protruding core 51 of the protruding bolt 5 and an indent 71 in the rotating screw bolt 7, and an external screw thread 72 on the external surface of the rotating screw bolt 7 is screwed with a thread section 112 at a distal edge of the through hole 111 that is disposed transversally at the protrusion 11 in the hinge body 1 for adjusting the resilience of the long spring coil 6. A vertical inner hole 113 is disposed at the center of the through hole 111 for installing an axial bolt 3, and a groove 31 formed on both upper sides of the axial bolt 3 is provided for pressing the protruding bolt 5 by the resilience of the long spring coil 6, and the bottom of the axial bolt 3 is situated and fixed into a center hole 411 of a hole base 41 in the fixing base 4 on the ground, and two long screw bolts 4A are screwed into the fixing base 4 and extended out from the hole base 41 into an inner screw hole 421 of an extending body 42 for contacting two sunken surfaces 32 on both left and right sides of the axial bolt 3.

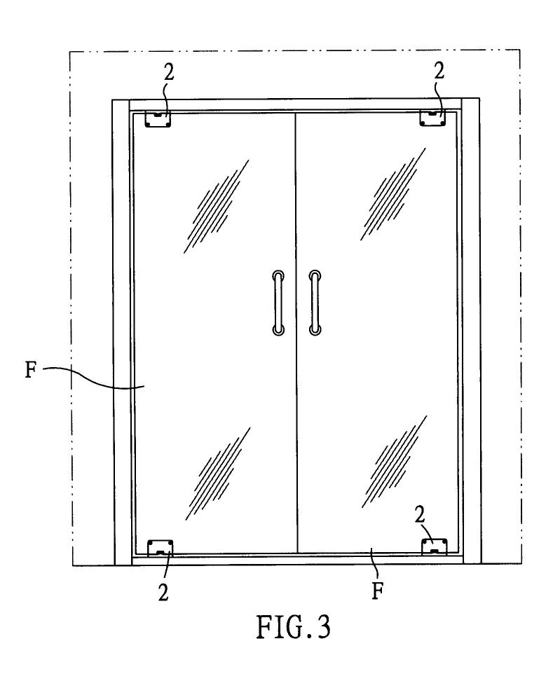

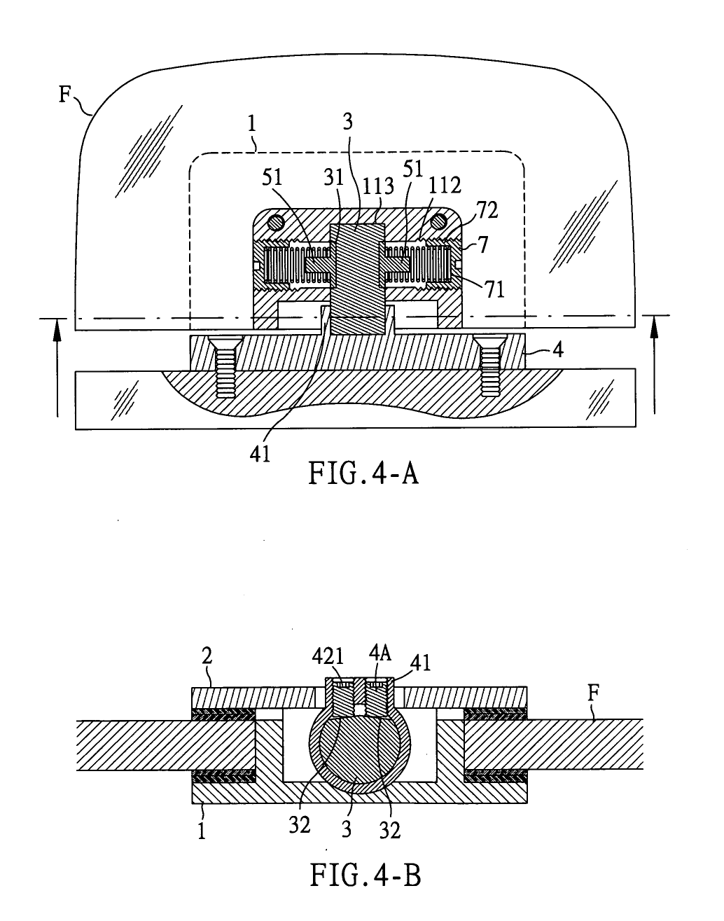

After two glass doors F are installed at the hinge body 1 and the hinge cover 2 as shown in FIG. 3, the two long screw bolts 4A in the extending body 42 disposed adjacent to the hole base 41 of the fixing base 4 fixed onto the ground are turned inward to press the axial bolt 3 or turned outward to rotate the axial bolt 3 to a certain angle as shown in FIG. 4B, so that both edges of the glass door F are turned slightly and accordingly, so as to achieve the effect of adjusting both edges of the glass door F to constitute a linearly smooth and neat glass door. Before the two long screw bolts 4A are in contact with two sunken surfaces 32 on both lower left and right sides of the axial bolt 3, the two long screw bolts 4A pass through an inner screw hole 421 of the extending body 42 extended from the hole base 41 in the fixing base 4. With the enhanced connection of the long screw bolts 4A to the extending body 42, easy damages to the screw thread of an inner screw hole can be prevented.

Since the length of the long spring coil 6 installed into both edges of a through hole 111 that is transversally disposed in the protrusion 11 of the hinge body 1 is increased by the protruding bolt 5 and the rotating screw bolt 7 on both ends as shown in FIG. 4A, the resilience can be enhanced, and thus the two glass doors F can be resumed to their closed position quickly.

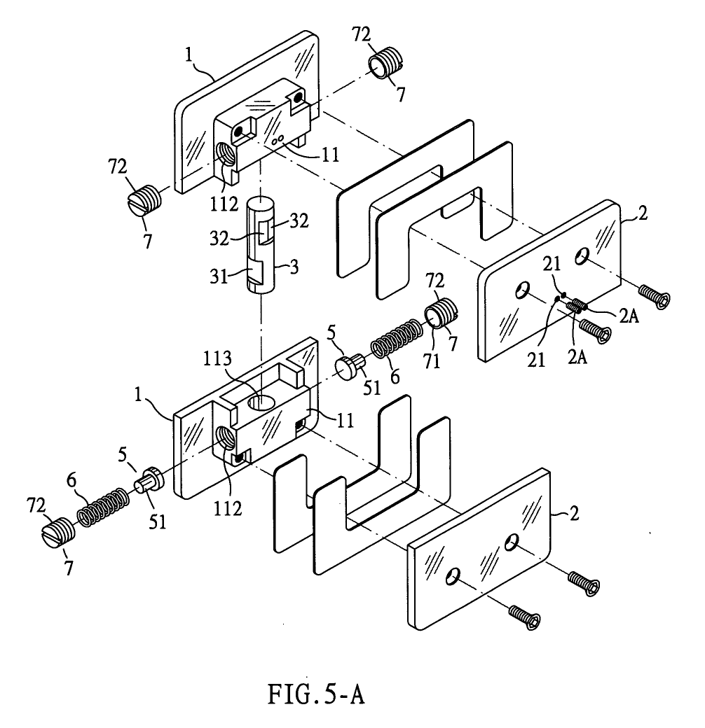

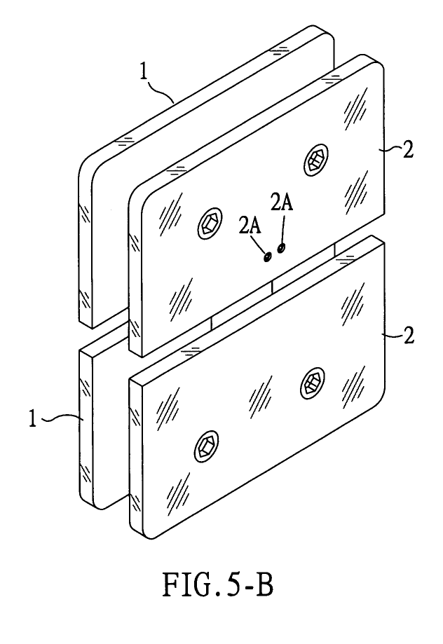

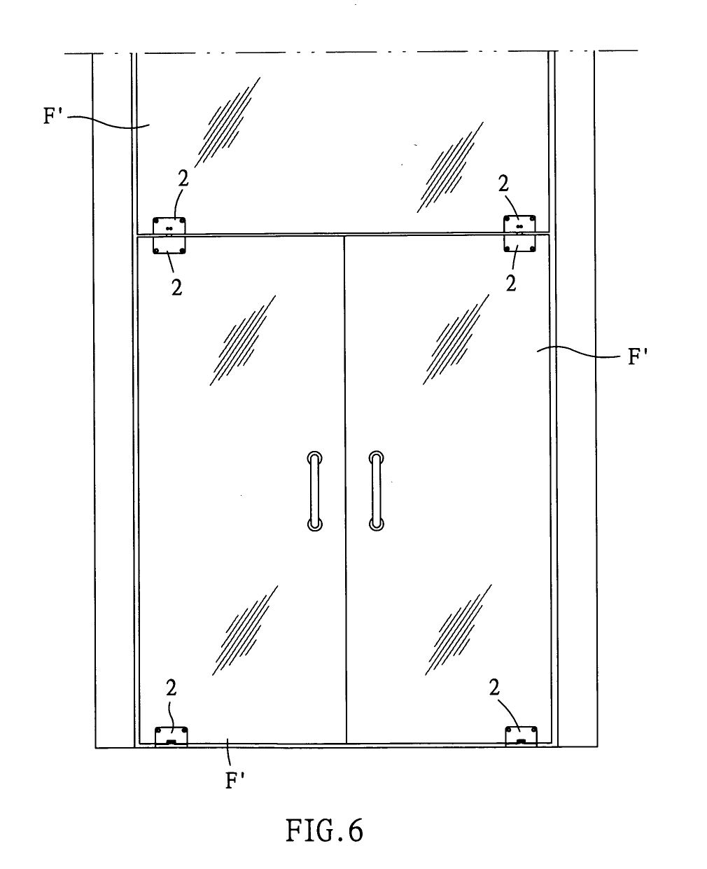

If the present invention is applied for making a glass door cabinet that can be closed by upper and lower glass doors F′ as shown in FIG. 6, two sets of hinge body 1 and hinge cover 2 work together with and an axial bolt 3 as shown in FIGS. 5A and 5B, and the sunken surface 32 and the groove 31 are disposed on both upper and lower sides of the axial bolt 3 respectively for installing the axial bolt 3 into the inner hole 113 at the central position of the protrusion 11 of the hinge body 1, and both ends of the long spring coil 6 at the bottom of the hinge body 1 can be clamped and fixed by a protruding core 51 of the protruding bolt 5 and an indent 71 in the rotating screw bolt 7, and an external screw thread 72 on the external surface of the rotating screw bolt 7 is screwed with a thread section 112 at a distal edge of the through hole 111 that is transversally disposed at the protrusion 11 in the hinge body 1 for adjusting the resilience of the long spring coil 6, and the long spring coil 6 presses the protruding bolt 5 against the groove 31 of the axial bolt 3 by the resilience of the long spring coil 6, and the screw holes 21 on the hinge cover 2 are provided for installing two long screw bolts 2A onto the sunken surface 32 of the axial bolt 3, so as to achieve the aforementioned effects.

In summation of the above description, the present invention definitely achieves the expected objective and provides an improved structure to enhance the performance over the prior art. The invention further complies with the patent application requirements and is duly filed for the patent application.

What is claimed is:

1. A glass door hinge structure, comprising a hinge body, a hinge cover, an axial bolt, and a fixing base, wherein a protrusion is disposed on said hinge body and attached onto an internal surface of said hinge cover, and said protrusion has a through hole disposed transversally on said protrusion, and both distal positions of said through hole separately include a thread section for installing and combining a protruding bolt, a long spring coil and a rotating screw bolt, and an external screw thread on an external surface of said rotating screw bolt is screwed with a thread section disposed at a distal edge of said through hole that is disposed transversally on said protrusion in said hinge body for adjusting the resilience of said long spring coil, and a vertical inner hole is disposed at the center of said through hole for installing an axial bolt, and said axial bolt is installed into said vertical inner hole of said protrusion in said hinge body and a center hole of a hole base in said fixing base, and a groove is disposed separately on both upper left and right sides, and a sunken surface is disposed separately on both lower left and right sides, and said fixing base includes a hole base, and said center hole of said hole base is provided for installing said axial bolt, and then two long screw bolts are screwed into said inner screw hole for contacting said sunken surface at both lower left and right sides of said axial bolt; characterized in that: both ends of said long spring coil are clamped and fixed by a protruding core of a protruding bolt and an indent in a rotating screw bolt for increasing the length of said long spring coil, and an extending body is extended from a position adjacent to said hole base in said fixing base, and said extending body has an inner screw hole, such that after said glass door is installed between said hinge body and said hinge cover, and said fixing base is fixed on the ground, two long screw bolts of said extending body on said fixing base can be turned to adjust an angle for making a smooth and neat glass door, and the connection of said long screw bolts can prevent said glass door hinge structure from being damaged easily, and the resilience of said long spring coils installed on both edges of said through hole that is disposed transversally on said protrusion in said hinge body protrusion can achieve the effects of extending the life expectancy of said glass door hinge structure and resuming said two glass doors to their closing position quickly.
